(19) United States
(12) Patent Application Publication
(10) Pub. No.: US 2017/0148109 A1
(43) Pub. Date: May 25, 2017

(54) SYSTEM AND METHOD FOR PROVIDING REAL-TIME LOCATION REVIEWS

(71) Applicants: Chon Hock Leow, Menlo Park, CA (US); Mark David Deyong Leow, Menlo Park, CA (US)

(72) Inventors: Chon Hock Leow, Menlo Park, CA (US); Mark David Deyong Leow, Menlo Park, CA (US)

(21) Appl. No.: 15/424,812

(22) Filed: Feb. 4, 2017

Related U.S. Application Data
(62) Division of application No. 14/075,767, filed on Nov. 8, 2013, now abandoned.

(51) Int. Cl. G06Q 50/00; G06F 17/30

(52) U.S. Cl. CPC G06Q 50/01; G06F 17/30241; H04L 12/2854

(57) ABSTRACT

Method and system for providing real-time location previews. For example, a system and method for collecting data about activity levels, including persons waiting in queues and density of persons, as well as environmental conditions of a location from one or more client devices and/or user devices; processing the collected data to remove privacy concerns, calculate queue times, density levels and other activity levels within a defined location, and retrieve contextual and historical information, including scheduled events, relevant to determining anticipated level of activity and environmental conditions within and around a location; and making processed data available to users via communications network for purpose of previewing a location.

### CROSS-REFERENCE TO RELATED APPLICATION

The present application is a divisional from commonly assigned parent application Ser. No. 14/075,767 filed on Nov. 8, 2013 and entitled SYSTEM AND METHOD FOR PROVIDING REAL-TIME LOCATIO PREVIEWS, the parent application herein incorporated by reference in its entirety.

### BACKGROUND

Embodiments consistent with the principles of the invention relate to mobile computerized devices and applications.

Smartphones and other web-enabled mobile devices have had a dramatic effect on how people make decisions about where to go and what to do. Using a web-enabled device, a person can readily access an increasing array of web resources to determine location options, reviews, environmental conditions and other information concerning specific places they wish to visit. For example, a group of people getting together can decide in-the-moment to go to a restaurant, and can access web-based resources to determine what restaurants are available in a particular location, what reviewers have said about that restaurant, and even book a table. In addition, they can access to some detailed information about the location and amenities. They can locate the restaurant on a map, view photographs or video clips showing the décor and available amenities, and read recent posts from prior patrons. Mobile access to detailed information provides persons with a greater degree of flexibility and spontaneity in that they can find what they want “on the go” and without prior planning.

There are now a variety of popular web-based resources (web sites, mobile device applications, review sites, and the like) aimed at providing detailed information about locations such as parks, civic areas, community spaces, retail establishments, event sites, and the like. These resources are increasingly focused on providing enough transparency to allow persons to make their decisions based on factors that may be important to them. For example, the popular web site and mobile application service Yelp! provides specific search and location tools, contact and address information, as well as reviews, ratings, comments, photographs, and suggestions, which would assist a mobile user in not only determining what options are available to them, but where they are, how to get there, and, to some degree, what to expect once they are there. Google Maps offers search tools, maps, suggested navigational options, information about available amenities, photographs, consumer reviews, and other contextual information such as what attractions and amenities are nearby. It can suggest popular destination locations, and show a user how to get there. Though helpful, the information provided by such web services is often static and/or not entirely current. The information does not present a picture of the activity and environmental conditions which approximates real time. For example, static photographs or video clips may show décor, amenities and activity at the time it was taken, but not in real time. Recent posts from patrons may detail what the scene was like recently, but not at the present time. And there is no information showing environmental conditions at the actual time a person is considering going to that location. For this reason, the user cannot necessarily rely on the information to determine whether the location suits her needs and desires at that moment, or to predict whether it will do so when she arrives at the location.

Some web resources, for example the social media sites Twitter and Facebook, may provide crowd-sourced information that is updated on a more current basis. Crowd-sourced sites provide tools for users to post reviews and comments, video clips and photographs, and other more current information. And web users, particularly mobile users, are now relying on these types of web resources to get more current information about locations they may be interested in going to at a particular moment. But even though the information provided by these crowd-sourced web resources is more current than static sites such as Yelp! and Google Maps, the information they provide is not current and consistent enough to adequately approximate real time information particularly with regard to information about activity and environmental conditions at particular locations. As a result, users cannot rely on them to accurately preview a location and determine whether a particular location will suit their needs at the present moment or by the time they arrive at the location. For example, a user may access a prior art web resource using a smartphone or other web-enabled mobile device to determine the location of a nearby café where she can purchase a cup of coffee and have a brief conversation before going to work. The web resource might help her find several cafes within walking distance, and provide hours and customer review information to let her know whether the café is open for business. The reviews may provide information on the general quality of service at that café. She may even be able to review recent posts showing photographs recently taken within the café or recent comments. But, the user cannot determine which café s currently have lines, how fast those lines are moving, or whether there are likely to be open tables in areas that are quiet enough to hold a conversation comfortably.

Prior art methods and systems for providing information that approximate real time also have significant limitations. For example, while it is possible for a commercial establishment to provide live video streaming on a website that might show present activity and conditions, very few do this because of privacy concerns. Owners of these establishments are often concerned that patrons do not want their whereabouts, activities or conversations broadcast to the general public, and owners may be worried about liability for violating privacy laws. In addition, live streaming to determine activity levels is not very effective because it is difficult for the user to interpret contextually. She may have to review a live video stream for 10 to 15 minutes to estimate how fast a queue (i.e. line of persons waiting to be served) is moving, which is not practical. And, there is no additional information that is provided to help the user understand whether the presently viewed stream shows normal activity and conditions or an anomaly which will change by the time the user travels to the location.

In fact, present methods and systems utilized by current web resources provide very little in the way of contextual information. A user cannot determine, for example, whether the current activity and environmental conditions are normal for a particular time of day or day of the week. And there is no information provided which would allow a user to determine whether the present conditions are likely to change by the time she arrives at a selected location. It is not uncommon for important conditions (such as number or density of persons, rate of movement in a waiting line, sound level or quality, temperature, and other conditions) to change substantially depending on the day, week, or month and/or whether a particular known event is occurring (or will soon occur) at a location or nearby. To make a decision about where to go in the moment, a user needs real time information about current activity and environmental conditions with contextual information that would help the user understand how relevant factors might change. The user needs to know, for example, how a line is moving at that time as well as information that would help her determine whether the line is likely to increase, speed up or slow down by the time she actually arrives at the location. Providing the user with information about norms is very helpful. But, other information, such as the occurrence of nearby events is also relevant. A particular restaurant might be busy on most Sunday afternoons except during football season when it is very busy. A bar located near a theater may be very busy before and after show times. Prior art methods and systems do not account for such events.

Many users rely most heavily on information they obtain through their web-enabled mobile devices when they are traveling or are unfamiliar with a particular city or town. It is not uncommon, for example, for persons arriving in a new city to want to determine not only what is going on but where people are congregating at that particular moment. A visitor may know, for example, that there is a festival going on in the city and that the festival takes place downtown. But the user may want to also know at what specific locations people are congregating. She may want to know where the busiest bars are at that moment. Or she may want to find a restaurant that is away from the center of activity but close enough so she can walk to the main activity after dinner. Prior art methods and systems simply do not provide this level of real time detail. While it may be possible to access popular social media based posting and communication sites such as Twitter, Facebook, and others to locate contextual information and historical “hot spots” of activity, this information is generally anecdotal, and can be inaccurate, outdated, and presented in a haphazard and inconsistent style. Importantly, they also do not provide readily accessible information showing real time activity levels or the location of resources and amenities close to areas of activity.

Prior art methods and systems fail to deliver real time information about activity levels, environmental conditions, and historical and contextual factors to allow users to determine whether a particular location will suit their needs and desires at the time they intend to go there. For example, prior art methods and systems fail to (1) provide real time information, (2) alleviate privacy concerns associated with video streaming, (3) accurately determine movement in lines or levels of service, (4) readily convey sound levels and sound quality at areas within a defined location, or (5) provide contextual information which would allow users to predict changes in activity and/or environmental conditions based on historical data and/or scheduled events.

### SUMMARY OF INVENTION

The limitations of the prior art are solved by the methods and systems consistent with the principles of the invention. Some embodiments, for example, include devices, systems and methods for providing previews, summarized information, and predictions about activity and other environmental conditions occurring within and around locations within defined time frames.

Some embodiments utilizing methods consistent with the principles of the invention include, for example, collecting environmental data on temperature and noise levels through use of sensors located in and around a defined location, recording the collected data, processing the data to remove privacy concerns, providing relative measurements, summaries, and predictions about anticipated changes depending on historical data and scheduled events. This information is made available to a user via computer, smartphone or other web-connected device.

In some embodiments, for example, the step of collecting environmental data includes recording video data of persons, then processing that data to identify and block facial information to alleviate privacy concerns. Users are able to view video clips showing activity, environmental conditions such as lighting, arrangement and size of seating areas, readily accessible amenities, types of services being provided, dress and décor of patrons and other visual cues which would assist a user in determining whether a particular environment would suit their needs and preferences. For example, a video image may show a seating area with servers serving food or a line of persons waiting to be served. A video image may show nearby amenities such as a covered outdoor smoking area accompanied by information about the environmental conditions such as temperature, moisture level, light levels, and the like.

In some embodiments, video images and environmental information is provided on a continuously updated basis. For example, some embodiments allow video images to be separated into clips of particular lengths and posted on a continuously updated fashion to provide real time information to the user. Previously posted clips may be replaced by more current clips and/or archived. Sound information may be recorded over a corresponding period of time and summarized numerically or graphically for easy comprehension by the user. Current information may be associated with historical data and other contextual information to allow users to make comparisons and predictions based on time of day, day of the year/month etc. or in correlation with scheduled events such as nearby sporting or entertainment events.

In some embodiments, for example, video data is recorded, processed and then presented to the user in a time lapse playback. For example, video may be recorded every 3 or 10 frames per second (or, alternatively, processed to removed frames) thus resulting in playback at 10 or 3 times the normal speed of 30 frames per second. This allows a user to view activity occurring within a 10-15 minute timeframe in a fraction of the time it took to record the activity. The user may thus assess movement of persons standing in a line or the activity of servers waiting on tables in a fraction of the time it would take to view a video stream of the same activity. In some embodiments, actual measurements of activity are determined and values are assigned to those measurements to assist the user in determining wait times and other activity levels (such as level of service, or table turnover) within a defined area.

Some embodiments, for example, enable recording of sound over time using one or more microphones. Sound levels may be measured over a time period, averaged, represented in decibels and/or graphic representations, or otherwise processed to provide a visual summary of the level and type of sound occurring over a recent time period. In some embodiments, sound may be analyzed for specific characteristics—for example, high frequencies representing shrieking and low frequencies representing booming sound. Processed sound information may be made available to the user on a consistently updated basis. The sound level and quality at a particular location (such as at a restaurant) could be important to users interested in finding a quiet place to hold a conversation or to avoid certain types of noise at certain time of the day. Sound may also be an indication of energy and activity within a defined space.

Some embodiments, for example, utilize two or more microphones within a particular area to help identify and map relative sound levels of areas within a defined location. For example, comparisons of sound recorded by microphones located in different areas of a table seating portion of a restaurant may show that, for example, the noise emanating from the bar area is of a certain average decibel level and consists of high frequency background noise, which would make it difficult for some users to hold a conversation, while the area near an opposite wall has noise levels and characteristics that are more conducive to conversation. Or, for example, that the tables located near the bar are actually less noisy than a user might predict by simply looking at a video stream.

Some embodiments, for example, measure and interpret recorded sound levels and sound frequencies occurring at a location. Numerical measurements and/or graphic representations of sound level and frequency are assigned to sound recorded with a video clip or independently. A condensed video clip, with accompanying information regarding level and frequency of sound, provides significant contextual information to help the user interpret activity levels of persons and/or environmental conditions occurring within the viewable area.

Some embodiments, for example, may utilize one or more temperature sensors to provide the user with information about temperature measured at a particular location within a period of time. This information may be particularly important to users who, for example, are interested in finding a restaurant where the temperature suits their needs and/or helping users understand what clothing may be appropriate to wear. Relative temperature information can be provided through temperature sensors (such as thermistors) located in separate areas of a defined location (for example, the indoor and outdoor seating areas of a restaurant). Similarly, barometric pressure sensors or moisture sensors (for measuring humidity levels for example) may be utilized, in some embodiments, to provide information as to weather conditions in and around a defined area. While a user looking at a video clip may determine that there are many persons in an outdoor seating area, information from sensors providing temperature, pressure and moisture information may provide the user with critical information about whether a particular location would suit her needs.

Some embodiments, for example, provide for receipt and processing of data (such as video images, photographs, sound, and/or temperature levels) sent by third parties. The information may be received, time stamped, and processed along with information recorded at the location site by fixed cameras, microphones, thermistors, or other sensors. User patrons of a restaurant may, for example, take video and/or sound recordings of specific locations using smart phones or other web connected mobile devices and provide that information via wireless transmission or mobile online connectivity. Global Positioning System (GPS) signals may be received by the system from users and others to provide information regarding the relative levels of activity or to calculate the number of persons within a particular area.

Some embodiments, for example, enable processing of GPS signals received from user mobile devices to measure movement within the defined area. Positioning signals and video data may be processed, for example, to determine not only the relative numbers of people in or near a particular location, but the rate of movement within a line, the rate of people moving in and out of a location over time, and other important contextual information. While GPS data is helpful for determining the relative numbers of persons within a general area, video data can be processed to determine for specific movements and rate of movements in a smaller area. A user who may be looking at a video clip of a long line at a café may be interested to know the relative rate of patrons entering a café or moving toward the line.

Some embodiments provide for the receipt, processing and display of crowd-sourced information regarding relative numbers of individuals in a particular area, existence and location of amenities of within a defined location, mapping of nearby commercial establishments, or other resources. For example, the system and method incorporates the use of GPS data received from one or more persons within a city to determine relative numbers of persons within a defined area (such as a downtown area consisting of several city blocks). Relative numbers of persons may then be mapped in juxtaposition to available amenities to show, for example, where people are congregating within a particular area of a city and what is available within or near the areas of activity. This has great advantages for user who might like to find the bar with the most (or least) people along a long city block or find a restaurant that is near a high level of activity. A user interested finding a restaurant away from but within walking distance of an area of higher activity can be directed to locations which suit her preferences.

Some embodiments provide for comparison of current data with data collected over a period of time to help predict environmental conditions for future time periods. For example, data collected consistently at a particular restaurant location for months or years can be archived and processed to help predict the level of activity and/or environmental conditions that may occur at that location within a particular time of the day, day of the week, or month in a year. Summaries and other representations of historical data may be made available to assist the user in understanding likely changes that may occur between the time the user is accessing the information and traveling to the location. For example, the system may provide a user with information showing a restaurant has been quiet within the past 30 minutes, but is likely to experience significantly increased activity within the next 30 minutes.

Some embodiments provide for processing of scheduling information which could have a predictive impact on the environmental factors within a particular location at a particular time. Information about events occurring at particular times may be processed along with historical data to help predict environmental conditions. Historical data may show, for example, that a restaurant or bar is normally very busy immediately following the home games of the local baseball team. A user interested in going to that restaurant may not be aware that a home baseball game is being played or that that it is likely to end within the next 30 minutes. Processing of scheduling information and notifications regarding the end of a game may be included within the analysis to assist the user in understanding that while the restaurant has been quiet for the last 30 minutes, it is likely to experience increased activity within the next 30 minutes.

In some embodiments, for example, the step of processing includes determining appropriate location options depending on one or more user-defined preferences related to activity or environmental conditions. For example, a user may request that the system provide suggestions for nearby café s where the line is moving at a certain rate or where the noise level is within certain parameters.

In some embodiments, for example, a user's preferences may comprise at least one of: a preference related to activity within a location; a preference related to sound level; a preference related to sound quality; a preference related to temperature; a preference related to existence of smoking; and a preference related to lighting levels and/or quality.

Some embodiments may include, for example, a computer program product, including a computer-readable program wherein the computer-readable program when executed on a computer causes the computer to perform methods in accordance with some embodiments.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Further, reference numerals may be repeated among the figures to indicate corresponding or analogous elements. The figures are listed below. The examples provided are for illustrative purposes and, for that reason, the depicted locations (café, restaurant etc.) are consistent for ease of understanding. However, it should be understood that the inventive system and methods are applicable to a variety of locations and uses including parks, stadiums, festivals, events for sporting events, commercial centers, and other locations where people congregate.

FIG. 1 is a schematic block diagram illustration of a system in accordance with some demonstrative embodiments.

FIGS. 2A and 2B are schematic block diagram illustrations of example embodiments of client devices, which may be utilized to collect, record, process, and transmit data about activity and environmental conditions within a defined location such as a café.

FIG. 3 is a schematic flowchart of a method of providing a preview in accordance with some demonstrative embodiments.

FIG. 4 is a schematic illustration representing the step of processing to remove privacy concerns, which may be used in accordance with some demonstrative embodiments.

FIG. 5 is a schematic illustration representing a method for providing visual representation of audio measurements, which may be used in accordance with some demonstrative embodiments.

FIG. 6 is a schematic illustration representing an example method of providing a preview in accordance with some demonstrative embodiments.

FIG. 7 is a schematic illustration representing an example of processing video and audio data to provide a preview.

FIG. 8 is a schematic illustration representing an example of the step of processing for determining queue waiting time.

FIG. 9 is a schematic illustration representing an example of the step of processing for determining sound levels and sound frequencies occurring within a specific location.

FIG. 10 is a schematic illustration representing an example embodiment of a preview display showing mapped activity within a defined area in accordance with some demonstrative embodiments.

FIG. 11 is a schematic illustration representing an example embodiment of a preview display showing mapped activity within a defined area in accordance with some demonstrative embodiments.

FIG. 12 is a schematic illustration representing an example embodiment of a preview display showing mapped activity within a defined area in accordance with some demonstrative embodiments

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Although portions of the discussion herein relate, for demonstrative purposes, to wired links and/or wired communications, some embodiments are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a Personal Navigation Device (PND), an Internet of Things (IOT) device, a hybrid device (e.g., a device incorporating functionalities of multiple types of devices, for example, PDA functionality and cellular phone functionality), a vehicular device, a non-vehicular device, a mobile or portable device, a non-mobile or non-portable device, a wireless communication station, a wireless communication device, a wireless Access Point (AP), a wireless Base Station (BS), a Mobile Subscriber Station (MSS), a wired or wireless Network Interface Card (NIC), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11ac, 802.11b, 802.11g, 802.11n, 802.16, 802.16d, 802.16e, 802.16m standards and/or future versions and/or derivatives of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or tag or transponder, a device which utilizes Near-Field Communication (NFC), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a “smartphone” device, a wired or wireless handheld device, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), OFDM Access (OFDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth®, Global Positioning System (GPS), IEEE 802.11 (“Wi-Fi”), IEEE 802.16 (“Wi-Max”), ZigBee™, Ultra-Wideband (UWB), Global System for Mobile communication (GSM), 2G, 2.5G, 3G, Third Generation Partnership Project (3GPP), 3GPP Long Term Evolution (LTE), 3.5G, 4G, Advanced LTE, or the like. Some embodiments may be used in conjunction with various other devices, components, systems, and/or networks.

Some embodiments may be used in conjunction with one or more types of sensors. The term “sensor” or “sensors” as used herein include devices for detecting and measuring levels of activity and/or environmental conditions such as light, sound, vibration, humidity, moisture, air quality, air pressure, and the like. Examples of sensors used to detect light and motion include cameras, video cameras, web cameras, and light meters, electronic motion detectors, camcorders, pocket video cameras, closed-circuit television cameras, pan tilt zoom cameras, IP cameras, and the like. Examples of sensors used to detect motion which are not cameras include electronic light sensitive motion detectors, air movement detectors, and the like. Examples of sensors used to detect sound include various microphones such as electromagnetic induction (dynamic) microphones, capacitance change (condenser) microphones, piezoelectric generation, or light modulation microphones, and the like. Examples of sensors used to detect temperature include thermistors, resistance thermometers, reversing thermometers, thermocouples, infrared thermometers, and the like. Examples of sensors used to detect air pressure include various types of barometers. Examples of sensors used to detect moisture levels include hygrometers, capacitive humidity sensors, resistive humidity sensors, thermal conductivity sensors, and the like. Some embodiments may be used in conjunction with various other devices, sensors, components, systems and/or networks. For example, a sensor may be used in conjunction with a codec (i.e. a device or computer program capable of encoding or decoding a digital data stream or signal) which encodes a data stream or signal for transmission, storage or encryption, or decodes if for playback and editing. Examples of codec standards include H.264, H.263, JPEG, HEVC, and the like.

The terms “wireless device” or “mobile device” or “mobile communication device” or “wireless communication device” as used herein include, for example, a device capable of wireless communication, a mobile phone, a cellular phone, a PDA capable of wireless communication, a handheld device capable of wireless communication, or the like.

The terms “web” or “Web” as used herein includes, for example, the World Wide Web; a global communication system of interlinked and/or hypertext documents, files, web-sites and/or web-pages accessible through the Internet or through a global communication network; including text, images, videos, multimedia components, hyperlinks, or other content.

The term “user” or “person” as used herein includes, for example, a person or entity that owns a computing device or a wireless device; a person or entity that operates or utilizes a computing device or a wireless device; or a person or entity that is otherwise associated with a computing device or a wireless device. A user is further defined as a person or entity which is using the computing or wireless device to access information from the system. In some instances herein, the device utilized by the user is called a “user device”.

The term “client” or “client device” as used herein includes, for example, a device or arrangement of devices for collecting information regarding activity and environmental conditions within a location, processing, storing and transmitting that data to a server via communications network. Various examples of client devices are provided. In some of the examples provided, a “user device” may be substituted (or the same) as a “client device.”

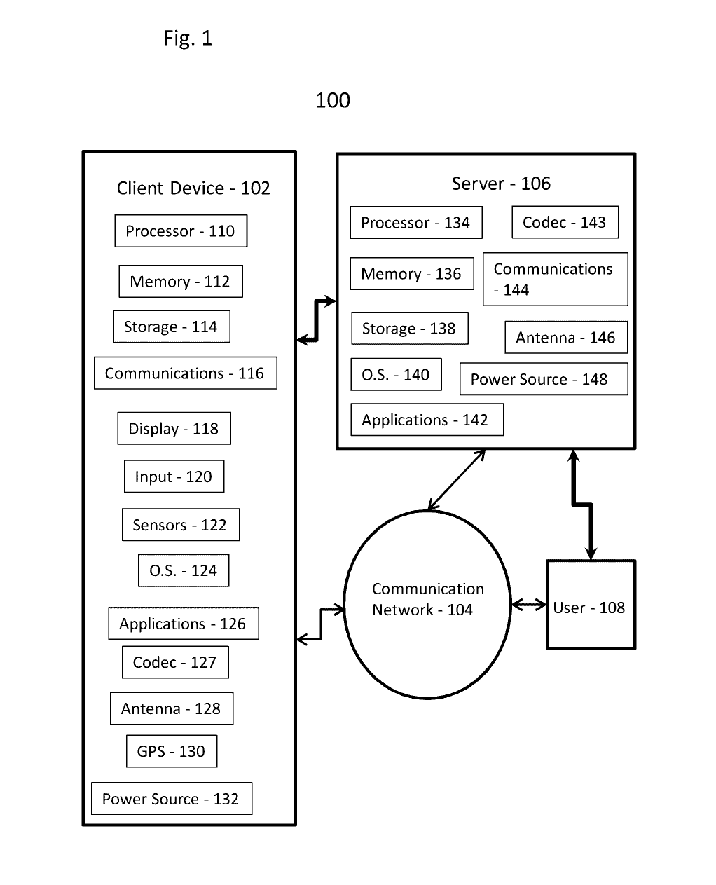

FIG. 1 schematically illustrates a block diagram of a system 100 in accordance with some demonstrative embodiments. System 100 includes one or more client devices, for example client device 102, a communications network 104, one or more servers 106, as well as one or more users 108.

In some embodiments, each one of the client devices 102 may be implemented, for example, as a fixed or portable device having power, processing capability, memory, networking capability, and which has, or is, attached to (or with) one or more sensors such as, for example, a camera, a video camera, a web-camera, microphone, a thermistor, a barometer, a light meter, a wireless signal detector, and the like. Examples of client devices include, for example, cellular phones, smartphone devices, Personal Digital Assistant (PDA) devices that have or are connected with one or more sensors. Other examples include a computer, web-enabled video camera or “web cam”, or other arrangement having processor, memory, networking capability and which is connected with one or more sensors.

The one or more client devices 102 and one or more users 108 may communicate among themselves, and/or may be able to communicate with one or more servers 106 using one or more communication links (wired or wireless) and/or one or more communications networks 104 such as the Internet. In some examples, the one or more users may communicate directly with the one or more client devices 102. Communication may be performed using one or more suitable protocols, for example, Transmission Control Protocol (TCP), User Datagram Protocol (UDP), Hypertext Transfer Protocol (HTTP), Wireless Application Protocol (WAP), or other suitable protocols. Communications may include transmission from client device 102 to server 106, for example, transmissions by client device 102 of its location, data collected by one or more sensors, processed data, historical data, and information regarding the time certain data was collected by sensors. Communications may include transmissions by server 106 to client device 102, for example, information regarding the configuration, intensity, direction of the sensors or information for directing the amount of type, amount, or timing of information to be transmitted by the client device 102 to the server 106.

Each of the one or more client devices 102 may be implemented using suitable hardware components and/or software components. For example, client device 102 may include a processor 110, a memory unit 112, a storage unit 114, a communications unit 116, a display unit 118, an input unit 120 and/or other suitable components and will include or be connected with one or more sensors 122.

A processor 110 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or other suitable multi-purpose or specific processor or controller. The processor 110 executes instructions, for example, of an Operating System (OS) 124 and one or more applications 126. In some embodiments, one or more codecs 127 (i.e. devices or computer applications capable of encoding or decoding a digital data stream or signal) may be used in conjunction with one or more sensors for encoding a data stream or signal for transmission, storage or encryption, or decoding a data stream for playback and editing. Examples of codec standards include H.264, H.263, JPEG, HEVC, and the like and/or one or more codecs 127.

An input unit 120 includes, for example, a keyboard, a keypad, a mouse, a touch-pad, a touch-screen, a joystick, a track-ball, a stylus, or other suitable pointing unit or input device.

A display unit 118 may include, for example, a Liquid Crystal Display (LCD) display unit, a Light-emitting Diode (LED) display unit, a plasma display unit, or other suitable types of displays or screens. In some embodiments, the display unit may include a touch-screen, such that the display unit may be able to present output as well as to receive touch-based input or multi-touch input.

A memory unit 112 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units.

A storage unit 114 includes, for example, a hard disk drive, a floppy disk drive, a solid state drive, a Compact Disk (CD) drive, a CD-ROM drive, Digital Versatile Disk (DVD) drive, an internal or external database or repository, or other suitable removable or non-removable storage units. The memory unit 112 and/or storage unit 114 may, for example, store data received from sensors 122 or processed by the processor unit 110 and/or data received from the server 106 or one or more users 108.

A communication unit 116 includes, for example, wired or wireless transceiver, a wired or wireless modem, a wired or wireless Network Interface Card (NIC) or adapter, or other unit suitable for transmitting and/or receiving communication signals, blocks, frames, transmission streams, packets, messages and/or data. In some embodiments, for example, the communications unit 116 may include a wireless Radio Frequency (RF) transceiver able to transmit and/or receive wireless RF signals, e.g., through one or more antennas 128 or sets of antennas. For example, such transceiver may be implemented using a transmitter, a receiver, a transmitter-receiver, or one or more units able to perform separate or integrated functions or transmitting and/or receiving wireless communication signals, blocks, frames, transmission streams, packets, messages and/or data.

An antenna 128 may include an internal and/or external antenna, for example, a RF antenna, a dipole antenna, a monopole antenna, an omni-directional antenna, an end fed antenna, a circularly polarized antenna, a micro-strip antenna, a diversity antenna, or any other type of antenna suitable for transmitting and/or receiving wireless communication signals, blocks, frames, transmission streams, packets, messages and/or data.

A client device 102 may optionally include a GPS receiver 130 able to receive signals from one or more satellites (or other signal sources) and to determine the spatial location of the client device 102, for example, based on trilateration or other suitable method.

In some embodiments, the client device 102 further includes a power source 132, for example, a power-cell or battery, a rechargeable power-cell or battery, one or more electrochemical cells, a lithium ion (Li-ion) battery, a Li-ion polymer battery, a nickel cadmium (NiCd) battery, a nickel metal hydride (NiMH) battery, a nickel hydrogen (NIH2) battery, or the like. The power source 132 may be associated with a power controller, which may be able to control, regulate and/or modify the power (e.g. the voltage and/or the current) supplied by the power source 132 to other components of the client device 102 (e.g. to the processor 110, to the display unit 118, or the like).

In some embodiments, some or all of the components of the client device 102 are enclosed in a common housing or packaging, and are interconnected or operably associated using one or more wired and/or wireless links.

In some embodiments, any one of the one or more client devices 102 may include components which may be similar to the components of another of the one or more client devices 102. In some embodiments, the one or more servers 106 may include components which may be similar to the components of any of the one or more client devices 102, for example a processor 134, a memory unit 136, a storage unit 138, an OS 140, one or more applications 142, one or more codecs 143, a communication unit 144, an antenna 146, and the like. In some embodiments, any of the one or more servers 106 may be stationary, non-mobile or non-portable.

In some embodiments, any one of the one or more client devices 102 may include components which are similar to components of the devices used by one or more users 108. The term “user” as used herein includes, for example, a person or entity that owns a computing device or a wireless device; a person or entity that operates or utilizes a computing device or a wireless device; or a person or entity that is otherwise associated with a computing device or a wireless device. A user may be utilizing a device which has the same or similar components as the client device 102 to access information from the one or more servers 106. For example, a user may access information using a smartphone which has all or some of the components of a client device 102 and may have the ability to be utilized as a client device for purposes of the methods outlined below.

In some embodiment of the system 100, a preview of activity and/or environmental characteristics may be based on data collected from multiple sources. A first data source may include, for example, video footage and accompanying sound taken by a client device connected with a web camera and microphone of a line of persons waiting to be served in a café. Such data might be collected primarily for the purpose of determining how many people are currently standing in line and how fast the line is moving. But, that data may also be collected and accumulated for historical analysis and/or, for example, determining how busy the line gets on particular times in a day, days of a week, or in conjunction with scheduled events. An example of a scheduled event might be, for example, a sporting event scheduled to take place at particular time at a venue near the café location.

A second data source may include, for example, video footage showing activity of persons such as numbers of persons in a specific area or persons standing in a queue or persons moving in and out of a defined space, as well as accompanying sound from a client device positioned in an adjoining seating area of the café. It also may include data taken from sensors which sense environmental conditions particularly relevant to persons using the seating area, for example sound level or quality, light quality, temperature and other factors. That data may be used primarily for determining the current number of empty tables, the rate of turnover of tables, the quiet or load spots and their locations, sound quality etc. and/or could be collected for historical purposes.

A third source of data may be data collected and transmitted by a user via user device. For example, a user may frequent the particular café and, using a smart phone or other user device, record video with accompanying sound of persons moving in and out of a space, standing in a queue or seated at tables. That video footage and accompanying sound may contain metadata allowing determination of when the video footage was taken and, by accessing wireless communications services within or outside the coffee shop, the user may transmit the information to the server for analysis along with the data collected from the first and second data sources. Other information, such as location signals (GPS) may be transmitted by users and processed at the server. This information may provide information about the density or movement of persons within a particular area.

A forth data source might be historical data and/or event schedule information made available to the server either through input or received from other databases and/or web based applications. For example, historical information stored on the server database regarding the activity and/or environmental conditions of a particular location could be accessed to help provide comparisons or predictions. Scheduling information made available to the server (such as the occurrence of an event at a scheduled time near the coffee shop) might be made available via connection with a web-based calendar and event schedule provider. The server may be instructed, for example, to obtain the schedule of all home games of the local sports team, theater information, or information about time, location and size of coming events. The data from the various data sources may be aggregated and processed to help form the preview.

In some embodiments, data collected from these various sources may be stored by the server 106 in a central database 138. In some embodiments, some data may be stored at the one or more client devices 102.

In some embodiments, the processing of the data collected from these various sources may be fully or partially processed at the client devices and/or server to maximize speed, reduce costs, to maintain integrity or speed of transmission and other factors. For example, video footage may be partially processed at the client device to identify faces with the face blocking performed at the processor located at the server because face blocking at the client device may require too many processing resources and slow down other functions of the client device which are deemed to be of higher priority. Sound may be recorded over a period of time, time stamped and compressed at the client device and transmitted to the server. The sound clip may then be processed at the server to measure volume, assign numerical or graphic representations or otherwise determine sound quality.

In some embodiments, data may be collected and/or analyzed only with regard to registered users who pre-approve their participation. For example, user participation registration may be performed using Web interface (e.g. filling out and submitting a form on a web-site) and/or through agreement with other web based application providers. For example, users may give their permission via registration to use the positioning signals transmitted by their smartphones or mobile devices to help determine the number of persons who are located in a particular area of a city at a particular time.

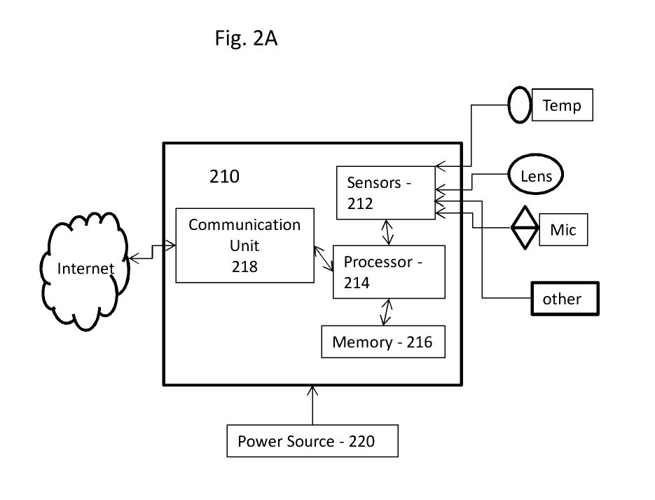

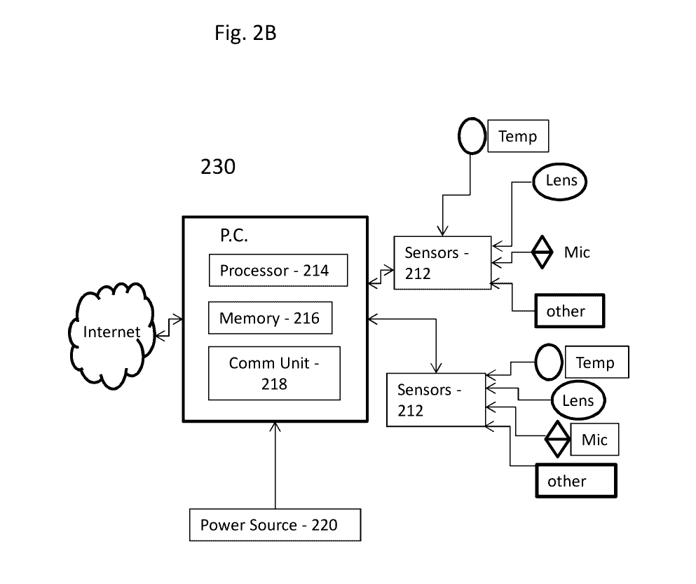

FIGS. 2A and 2B are schematic block diagram illustrations of example embodiments of client devices, which may be utilized to collect, record, process, and transmit data about activity of persons and environmental conditions within a defined location such as a café.

FIG. 2A shows an example embodiment of a client device configuration 210, which might be a webcam, smartphone or similar device having a housing containing one or more sensors 212, a processing unit 214, memory 216, communications unit 218 and power source 220. The one or more sensors 212 may be housed within or connected with the device. Examples of typical sensors would be a video camera having one more lenses and one or more microphones. Sensors might also include temperature sensors such as a thermistor, and/or other environmental sensors such as a moisture meter as discussed in relation to FIG. 1 above. The client device configuration shown in FIG. 2A might be most appropriate as a stand-alone client device which could be mounted to a wall of a café, for example, to record the movement of persons standing in a queue as well sound within the vicinity of the queue. The client device configuration 210 could be connected with one or more servers using a wireless or wired communications network such as the internet.

FIG. 2B shows an alternative example embodiment of a client device configuration 230, which might be one or more webcams (or other devices having sensors) connected with a PC. The one or more sensors 212 may be positioned in various locations within a single location and transmit data (through wired or wireless communication links) to one or more local PC's each having a processing unit 214, memory 216, communications unit 218 and power source 220. The client device configuration show in FIG. 2B could be utilized in a restaurant location having multiple areas or activity to record and analyze. For example, the one or more sensors 212 may be appropriate for positioning at or near the seating area and may comprise, for example, a video camera with microphone, thermometer/thermistor. Each of the sensors may be coupled with its own processing unit, memory, and communications unit. Or, alternatively, each of the sensors may simply transmit recorded data to the PC to carry out processing, memory and communication functions. Again, this configuration may be most appropriate for use in calculating availability of seating, sound levels and frequency, including the relative levels and characteristic of sound emanating from one or more separate areas within the seating area, air temperature and/or other environmental conditions within the seating area. The one or more sensors 212 may be in wired or wireless communication with one another and/or with the P.C. Upon receipt of data from the sensors, the PC may further process the data and/or record and transmits the processed data to the server (not shown) via communications network.

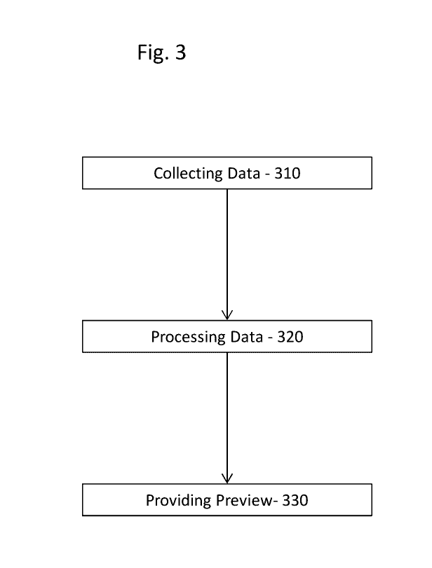

FIG. 3 is a schematic flowchart of a method of providing a preview in accordance with some demonstrative embodiments. Operations of the method may be used, for example, by system 100 of FIG. 1, and/or by other suitable units, devices and/or systems.

In some embodiments, the method may include the step of collecting data (block 310).

The step of collecting data may include, for example, collecting data about levels of activity, density of persons, and environmental conditions from client devices and/or users via user devices including, for example, location information, video images, sound, temperature, humidity levels, and other environmental conditions.

The step of collecting data may include, for example, obtaining event scheduling information from third party resources such as websites or other electronically stored databases. It may include, for example, accessing historical information recorded on the server or obtained from third party resources such as websites or other databases.

In some embodiments the method may include the step of processing data (block 320).

The step of processing data may include, for example, identifying, removing, or obscuring images of persons' faces captured within recorded video images (i.e. face blocking), calculating movement in a line or persons depicted on a video stream or clip, removing frames within a recorded video stream, or combining images taken at intervals to enable condensed playback of a video clip of predetermined length.

The step of processing data may include, for example, determining average audio (i.e. sound) levels in decibels and/or determining sound characteristics (such as frequency) recorded by one or more microphones over a period of time. Processing may include, for example, assigning numerical or graphic representations of sound level or characteristics, determining relative audio level or frequency by comparing sound recorded by two or more sensors, and/or making predictive representations of sound based on scheduled events and the like.

The step of processing may include, for example, comparing data collected from client devices with that received from users, comparing stored historical data regarding activity of persons including both queue time calculations and density calculations, as well as environmental conditions and characteristics of a defined location with data recently collected at that location, creating predictions based on scheduled events or other data including but not limited to data (such as GPS signal information) showing changes in activity at or near a location. Examples of processing may include mapping locations of activity based on calculated queue times and density determined through the use of video data as well as crowd source data (such as GPS and/or video data) depicting the relative density and movement of persons within a defined location and providing information regarding the location of nearby commercial establishments and amenities.

The step of processing may occur at one or more client devices and at one or more servers. Processing may occur partially at the one or more client devices and partially at the one or more servers. The step of processing may occur simultaneously at one or more client devices and at the one or more servers.

In some embodiments, the method may include the step of providing one or more previews (block 330).

The step of providing one or more previews may include, for example, showing a time lapse 3 minute video clip recorded over the previous 10-15 minutes of persons standing in a queue at a café with average level of sound measured in decibels. It may include providing calculations of how fast the queue was moving within the recorded time frame. It may include measurements of other environmental conditions, such as temperature measured during that recorded time frame. It may include an indication of how the conditions measured within the time frame relate to historical data showing average measured conditions for time of day, day of the week, etc. It may include providing contextual information to assist the user in predicting the likelihood that the conditions measured within the recorded 10-15 minute time frame might change depending on scheduled events or other factors. The step of providing may also include showing a map indicating relative levels of activity within a defined area of a city.

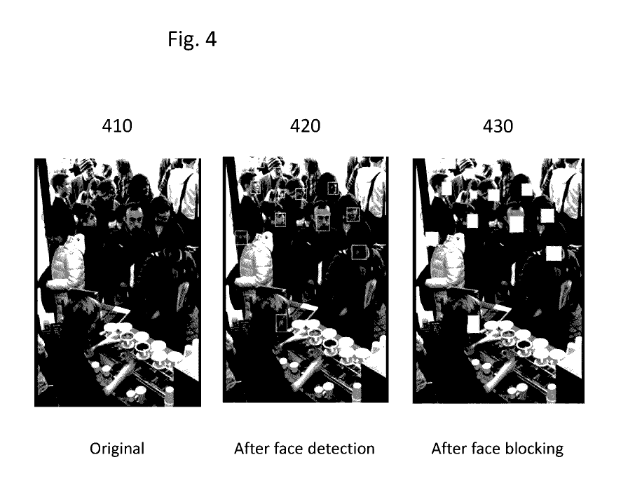

FIG. 4 is a schematic illustration representing the step of processing to remove privacy issues which may be used in accordance with some demonstrative embodiments.

An example of the step of processing to remove privacy issues as shown in FIG. 4 includes obtaining original video images of persons standing in a queue to be served (Frame 410), identifying portions of the video images which corresponds to the faces of persons standing in the queue (Frame 420), and blocking and/or obscuring the data corresponding to the faces of persons standing in line (Frame 430). Frame 430 is also an example of a frame of video that may be provided to users to indicate activity within a queue.

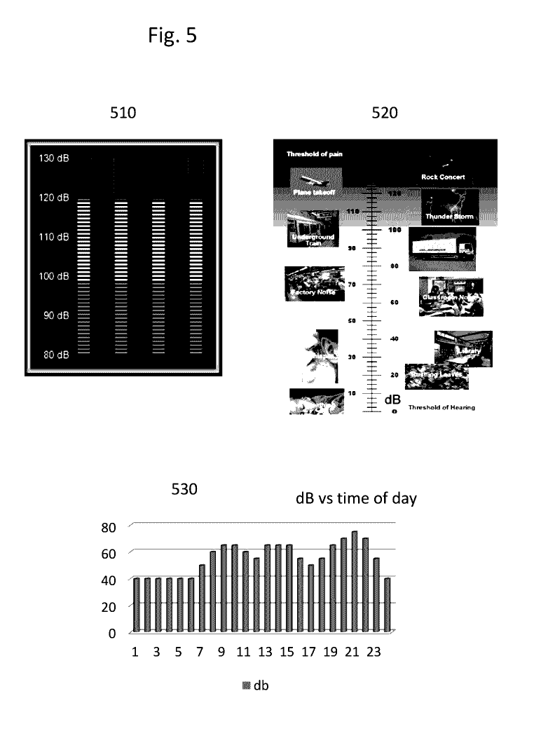

FIG. 5 is a schematic illustration representing a method for providing visual representation of audio measurements which may be used in accordance with some demonstrative embodiments. The example depicts sound recorded over time which has been processed to calculate average sound levels. The sound levels in this example are represented in a graphic representation showing decibels (Frame 510), in a graphic representation comparing the sound levels to other know sound sources (Frame 520), and in a graphic representation showing average decibel levels recorded within 1 hour time frames which are time stamped and plotted over a 24 hour period (Frame 530). The plotted time frames may vary in length as desired. For example, the average decibel level may be recorded in 10 minute time frames, averaged for each time frame and plotted over the previous hour.

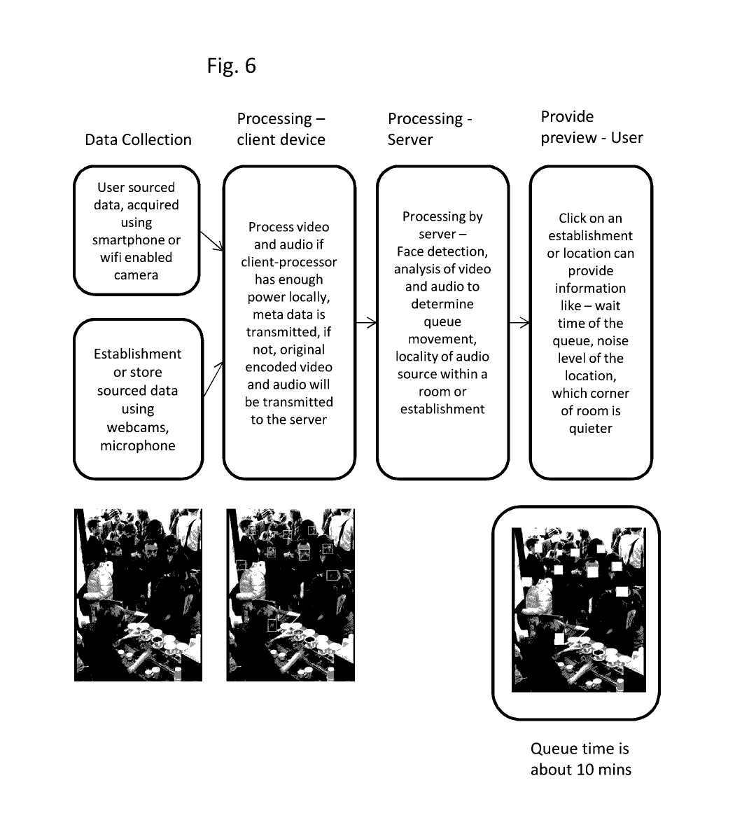

FIG. 6 is a schematic illustration representing an example method of providing a preview in accordance with some demonstrative embodiments. In this example, a video clip showing persons waiting in a queue (i.e. line) to be served. The faces of persons in the queue have been blocked. The average wait time has been calculated and is provided below the video clip.

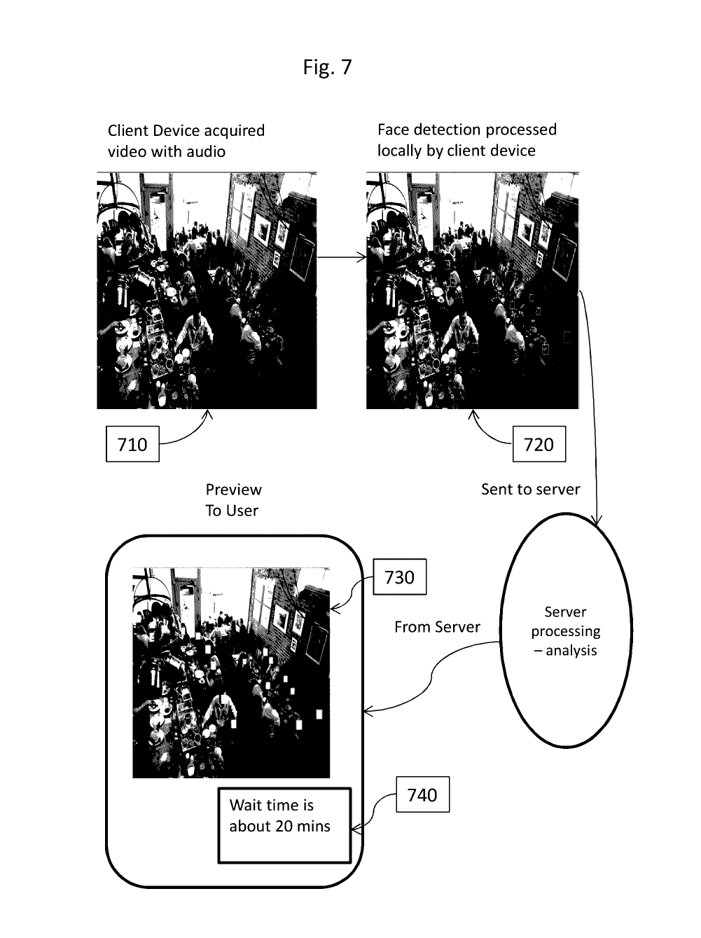

FIG. 7 is a schematic illustration representing an example of processing video and audio data to provide a preview. In this example, video images along with audio are collected at the client device (Frame 710), the video images are processed at the client device (Frame 720), the video and audio data is sent to a server where the video is further processed to remove facial data, and calculate queue waiting time (Frame 730). A preview is provided to the user showing the video images with facial information blocked out and calculation of the waiting time (Frame 740).

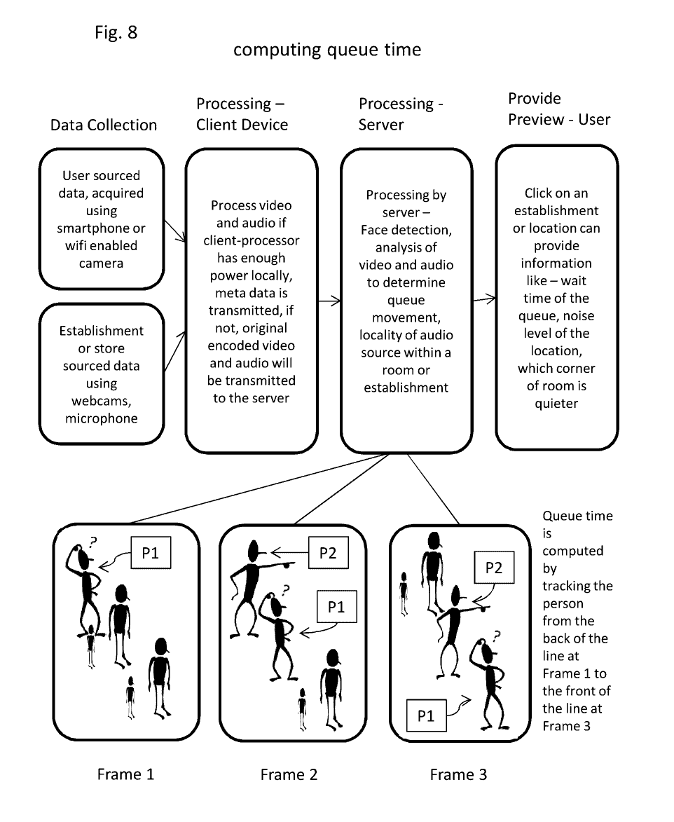

FIG. 8 is a schematic illustration representing an example of the step of processing for determining queue waiting time. The example could pertain to a variety of situations including but not limited to a queue of one or more persons waiting to be served at a café. In this specific example, video data recorded by a client device such as a webcam installed in a café, or user device such as a smartphone, web-enabled or wifi-enabled device, is processed to determine the time it takes for a person to reach the front of the queue.

FIG. 8 shows three frames of video data (marked as Frame 1, Frame 2 and Frame 3) showing the movement of persons standing in a three person queue. At Frame 1, a new person P1 has taken a position at the back of the queue. Identification of the new person P1 taking a position at the end of the queue is made using facial detection and his inclusion into the queue is time stamped T1a and attributed to P1. Looking at Frame 2, another person P2 is identified as having entered the queue using facial detection. Another time stamp T2a is made and attributed to P2. In Frame 3, the person identified at P1 has moved to the front of the queue to be served and another time stamp is noted T1b and attributed to P1. The time T1a is subtracted from the time T1b to determine P1's time-to-be-served T1c. Similarly, when P2 moved towards to the front of the queue to be served another time stamp T2b is noted. T2b minus T2a will determine P2's time-to-be-served, T2c. The queue time (i.e. the overall time-to-be-served as provided to the user) may be calculated by averaging the various time-to-be-served of the persons in a queue (P1, P2, P3 etc.) over a period of time. In this case, the time-to-be-served average does not include the potential additional time needed for person's food to be prepared and provided. However, such calculations are possible by making another time stamp T1d when the person (P1 for example) reaches a particular service area (the counter, for example) and determining when that person then leaves the counter T1e. In this example, the processing may occur partially at the client (or user) device and partially at the server depending on a number of factors including power, memory resources and processing speed.

Other types of calculations of time may be made using facial detection and time stamping which do not necessarily involve persons standing one behind the other in a queue. For example, the step of processing may include determining average waiting time in a waiting area by identifying persons and corresponding times when persons appear and leave a certain area and adjusting for anomalies (such as when a person leaves an area and returns within a substantially shorter time than the average waiting time). Many fast-food type restaurants have a queue where persons wait in line to make an order. Upon placing their order, they are given a number and wait in a general seating area for their number to be called so they can retrieve their order at a service counter. This method may be used to calculate the time-to-be-served by noting the time when a person places and order and the time when that person goes to a counter to pick up the order. The time-to-be-served to make the order may be significantly different from the time it takes for the order to be filled. Similarly, this method may be used to calculate other service times. For example, it may be used to determine when tables come available, on average, by determining the average time when persons are seated and comparing that time to when those persons leave. It may be used to determine how often a particular server (such as a person who fills water glasses) appears at table locations to provide service. Additionally, the method may be used in non-restaurant contexts. For example, it may be used to calculate time for movement of persons in an amusement park queue, or even the time it takes for persons to cross a bridge on foot. While positioning of client devices at locations where behavior of patrons is generally orderly and predictable is helpful to maintaining accuracy, there are a variety of anomalies (such as persons leaving and reentering queues) when can be accounted for using more complex calculations based on the same basic method.

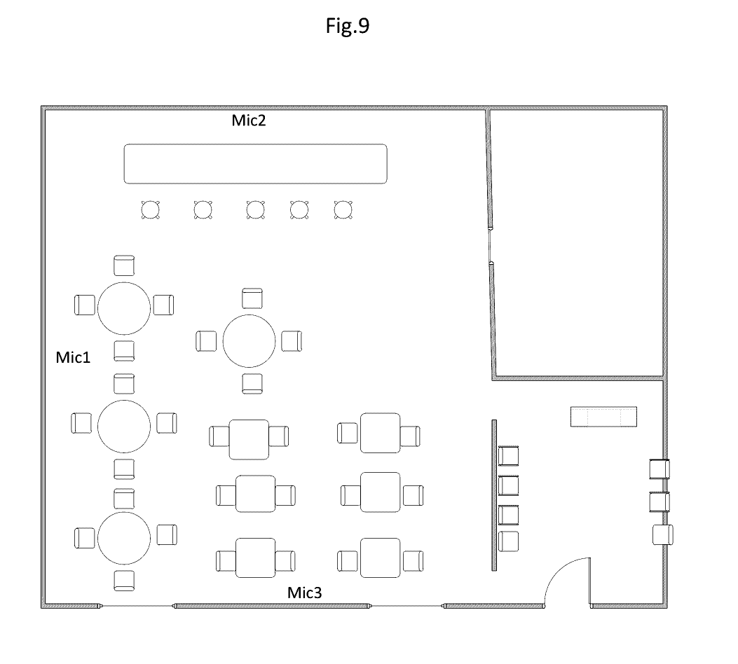

FIG. 9 is a schematic illustration representing an example of the step of processing for determining sound levels and sound frequencies occurring within a specific location. It is not uncommon for areas within a restaurant to differ significantly in sound level and frequency. FIG. 9 shows three microphones positioned at various locations within a restaurant. Microphone Mid is located along a wall adjacent to a seating area, Mic2 is located along a wall over a bar area, and Mic3 is located above a seating area near the entrance. The system may process the sound collected at each microphone independently to calculate the average sound level and frequency occurring within each area and/or it may calculate the relative sound levels and frequencies between the three areas. By comparing sound levels to mapped areas within the location, the system can calculate how many tables are positioned in areas having sound levels and sound frequencies that are conducive to normal conversation.

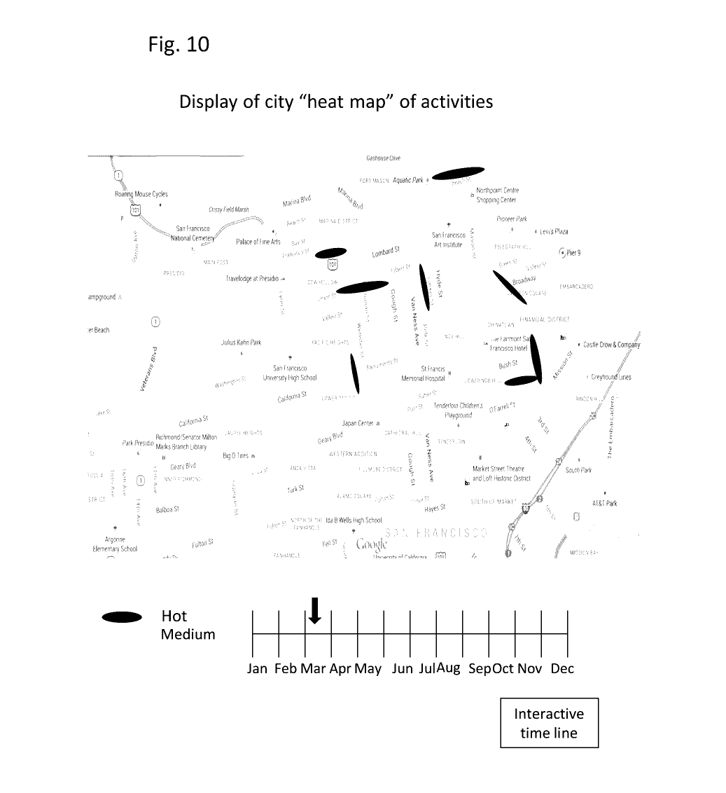

FIG. 10 is a schematic illustration representing an example embodiment of a preview display showing mapped activity within a defined area, in this case San Francisco, Calif. This example, called a “heat map”, refers to relative level of activity of persons within a defined area and not to temperature. It shows areas of relative activity by collecting and processing client device and/or crowd-sourced data (such as GPS signals and video) which indicate increased activity or persons within an area such as longer queue waiting times, higher density of persons, higher levels or particular frequencies of sound, higher levels of persons moving in and out of a defined area and the like. The relative areas of higher activity may be indicated on a city map using graphic indicators (such as shaded ovals or other shaped overlays of various sizes, shades and/or colors). In FIG. 10, for example, the size and color of an oval overlay indicates the area of relatively high density of persons in the area covered by the oval. However, the map could also include other data indicating higher activity levels such as queue times, service waiting times, sound levels and frequencies, and movement of persons and the like. In this example, certain areas of a city map are highlighted (using graphic indicators) to depict areas within the defined area on the map from which higher than average number of GPS signals have been received by the system within a predetermined period of time (as further discussed further below). The graphic indicator, in this case an oval, may be darkened (or colored red, for example) to indicate areas on the city map from which a much higher than average number of GPS signals have been received for that time period. In other examples, differing types of data may be processed and combined to show activity levels. The same or different graphic indicators may be used to show increased activity levels based on different types of data such as queue times. New data may be continuously collected and/or collected for a predetermined period of time. The data is processed and the map is updated continuously or at regular intervals to provide information that most approximates real time.

Adjustable filters/settings may be used to calculate relative activity levels. For example, relative city-wide activity levels may be calculated (at least to some extent) by collecting and averaging queue time data collected by client devices positioned throughout the city. Initially, for example, the system may calculate an average city-wide queue time of 10 minutes and show areas of relatively high density as those with average queue times that exceed the 10 minute average. Similarly, the system may calculate an average city-wide density level by collecting and processing data collected, for example, by client devices and GPS signals received from user devices. The system may, for example, calculate an average city-wide density of 50 persons per square block and indicate areas of higher density as those areas where density exceeds that city wide average. Alternatively, the calculations may be made using default standards. These filters/settings may be adjusted by the system according to the specifically defined area of interest (for example, by using data collected for a specifically defined area of the city determined by the user) or by the user manually adjusting them through a sliding level, pop-up menu, and the like. The adjustable filters/settings allow the user to control the calculation of relative density and/or activity to more accurately suit her needs.

The “heat map” is also adjustable by the user as to the time depicted by the map. FIG. 10, for example, includes an interactive time line divided into months of the year. In this case the information provided on the map is for the early part of March. By moving the pointer, the user may depict data relevant to other times of the year.

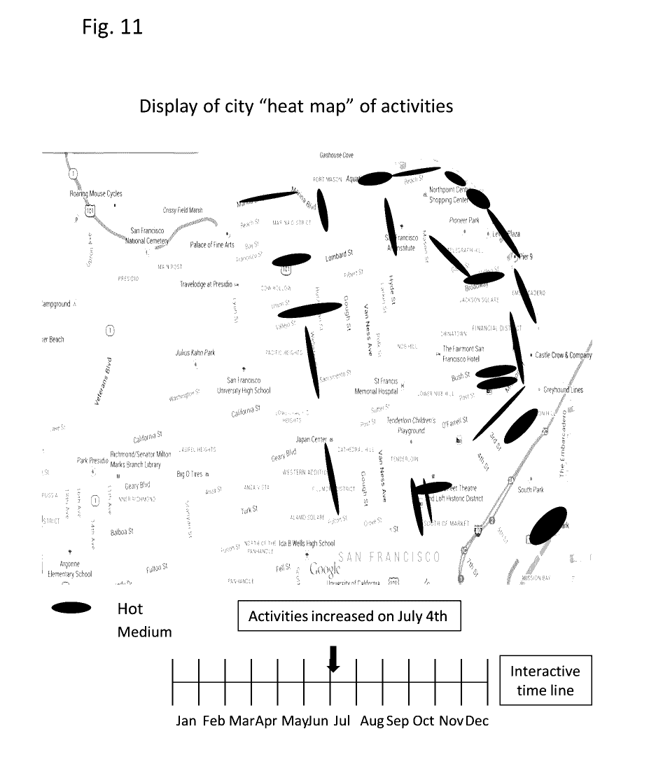

FIG. 11 shows another example embodiment of a “heat map” shown in FIG. 10 except that the interactive time line shows that the data depicted pertains to July 4^{th}, which is a time of relatively high activity within the city of San Francisco each year.

One should note that the information in the “heat map” may be current (i.e. approximating real time), historical, or predictive in nature. For example, the map depicted in FIG. 11 is for July 4. It may depict calculations of data collected at the date and time the user is accessing the information or it may depict calculations of historical data (for example, last July 4^{th}). It may also be predictive in the sense that it may incorporate information pertaining to scheduled events (such as baseball games) using historical data that will be likely to have a particular effect on activity in the future. The nature of the data (historical, predictive, current) depicted by the map can be determined to by the user by changing settings and filters.

As stated previously, the system may allow the user to adjust filters/settings to more accurately determine relevant information for a specific area of interest during a specific time frame (past, present or future). For example, the “heat map” may show a macro picture of the activities of a city with indications of relative activity determined according to certain standard settings and filters (such as average persons per square block or queue times of a certain length). The system could allow the user to zoom in on a particular district to get a more specific understanding of relative activity and density levels within that district. The user may keep the same settings (for example, averages calculated for the macro picture) or redefine the settings/filters using user controls, pop-up menus, and the like to obtain a more granular understanding of what is going on within a more locally defined area. The user may adjust the settings to incorporate current, historical, or predictive data.

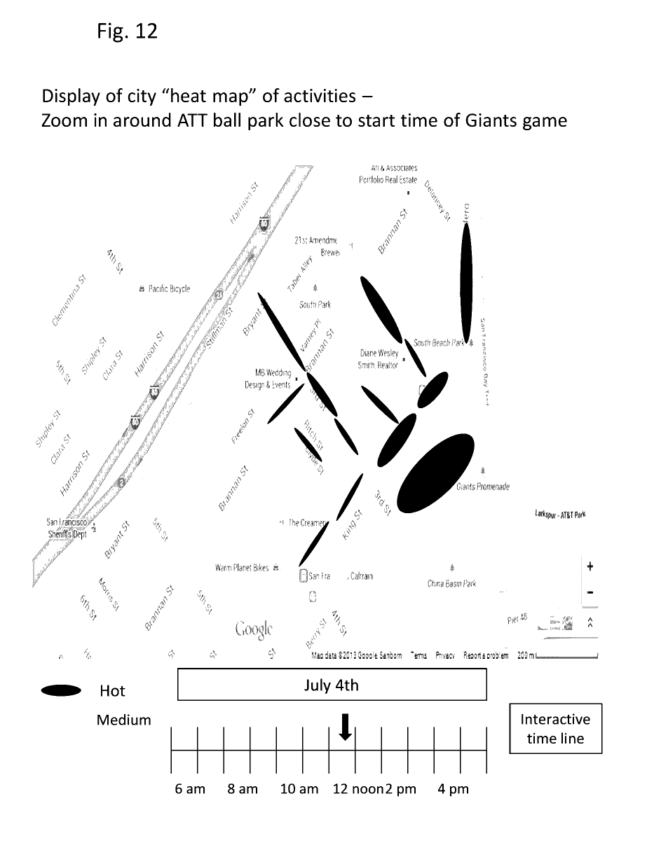

FIG. 12 shows an example embodiment a “heat map” for an area in and around AT&T Park (the home of the San Francisco Giants baseball team) at game time. In this example, the user has zoomed in on this more narrowly defined area to obtain a more granular understanding of activity in and around AT&T Park at approximately 12 noon on July 4th. Keeping in mind that this general area is particularly active during the time period, the user may want to change settings/filters to obtain more specific calculations of activity levels. For example, the user may be looking for an area of activity where the average wait time is less than 20 minutes, so she may change the queue time filter/setting from a standard 10 minutes (for example) to 20 minutes which would result in the system calculating relative areas of high activity based on a longer wait time. The user may change the density filter/setting from 50 persons per square block to 100 persons per square block which would also affect the calculation of relative density levels. In this way, the user will be shown relative areas of activity that are different (and possibly more relevant to her at this current location and time) than those shown should she rely on city-wide relative activity calculations. Other adjustments in setting/filters may be made including the relevant time period in which calculations are made. For example, the user may determine that the calculations for current data be made and updated over a 5 minute time period rather than a 15 minute time period. A variety of such options are available to the user in determining how the data will be processed to provide the most relevant data to the user.

It should be noted that the embodiments of systems and methods described above are for illustrative purposes. The provided examples are not meant to be exhaustive. Note that other suitable operations or sets of operations may be used in accordance with some embodiments. Some operations or sets of operations may be repeated, for example, substantially continuously, for a pre-defined number of iterations, or until one or more conditions are met. In some embodiments, some operations may be performed in parallel, in sequence, or in other suitable orders of execution.

Any discussions herein utilizing terms such as, for example, “processing,” “computing,” “calculating,” “determining,” “establishing,” “analyzing,” “checking,” or the like, may refer to operation(s) and/or process(es) of a computer, a computing platform, a computing system, or other electronic computing device, that manipulate and/or transform data represented as physical (e.g. electronic) quantities within the computer's registers and/or memories into other data similarly represented as physical quantities within the computer's registers and/or memories or other information storage medium that may store instructions to perform operations.

Some embodiments may take the form of an entirely hardware embodiment, and entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk-Read-Only Memory (CD-ROM), Compact Disk-Read/Write (CD-R/W), DVD, or the like.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the following claims are intended to cover all such modifications, substitutions, changes, and equivalents.

1. A system determining and predicting human density conditions at geographic locations, comprising;
a computerized server connected to a wide area network (WAN) storing and executing software;
an interface including a display, provided by the software, accessible by a user from a computerized appliance connected to the WAN;
a plurality of mobile computerized devices, connected to the WAN, storing and executing an instance of the software and GPS, the software controlling environmental, audio, and video sensors connected to the plurality of mobile computerized appliances;
stationary environmental, audio and visual sensors at a first geographic location; and
stationary environmental, audio and visual sensors at a second geographic location;
wherein software at the server receives a request from the user at the interface for information indicating current conditions and predicted human density conditions at the first geographic location, controls timing of data gathering and type of data gathering at all of the sensors based upon the received request, collects at least first data from the sensors at the first geographic location, second data from the sensors at the second geographic location, and third data from the GPS and sensors at the plurality of mobile computerized appliances, transforms the first, second, and third data generating at least a graphic human density map including the first and second geographic locations, and presents the map in the display in response to the request.

2. The system of claim 1 wherein the stationary sensors at both the first and second geographic location communicate with the plurality of mobile computerized devices or a local computerized device connected to the WAN and executing an instance of the software.

3. The system of claim 1 wherein the first and second data includes at least analog data that is transformed and used to create graphics also presented in the display.

4. The system of claim 1 wherein the server also gathers additional information including at least current and future public event schedules at third locations approximate to the first and second geographic locations, the additional information used to create a predicted human density map including the first and second geographic locations as a result of the request.

5. The system of claim 1 wherein the plurality of mobile computerized devices are smartphones, and metadata associated with the third data from the mobile computerized devices is used in the generation of the graphic human density map.

6. The system of claim 1 wherein the stationary sensors and the sensors on or connected to the plurality of mobile computerized devices are any one of a web cam, video, microphone, thermistor, barometer, light meter, and wireless signal detector.

7. The system of claim 2 wherein the control of the timing and the data gathering at all of the sensors occurs by communications from the server to the plurality of mobile computerized devices and local computerized devices, and includes;
a request for information regarding the configuration, intensity, and direction of the sensors, and
information for directing the type, amount, and timing of the first, second and third data.

8. The system of claim 4, wherein the first, second, and third data gathered by the server is stored as historical data to be utilized in the generation of the predicted density maps.

9. The system of claim 4, wherein the server determines current human density at least at a third geographic location via data gathered from sensors and GPS connected to mobile computerized devices at the third geographic location and uses that determination to predict human density at the first and second geographic locations creating a predicted human density map in the display representing the first and second geographic locations at a future time.

10. A method for determining human density and predicting conditions at geographic locations, comprising the steps of:
(a) receiving a request at a computerized server connected to a wide area network (WAN) storing and executing software, the request for information indicating current conditions and predicted human density conditions at a first geographic location;
(b) initiating audio and visual sensors at the first geographic location, at a second geographic location, and from sensors, including GPS, from a plurality of mobile computerized devices, the plurality of mobile communication devices executing an instance of the software;
(c) controlling, by the software at the server, timing of data gathering and type of data gathering at all of the sensors based upon the received request;
(d) collecting at least first data from the sensors at the first geographic location, second data from the sensors at the second geographic location, and third data from the GPS and sensors at the plurality of mobile computerized appliances;
(e) transforming the first, second, and third data generating at least a graphic human density map including the first and second geographic locations; and
(f) presenting the human density map in the display in response to the request.

11. The method of claim 10 wherein the stationary sensors at both the first and second geographic location communicate with the plurality of mobile computerized devices or a local computerized device connected to the WAN and executing an instance of the software.

12. The method of claim 10 wherein the first and second data includes at least analog data that is transformed and used to create graphics also presented in the display.

13. The method of claim 10 wherein the server also gathers additional information including at least current and future public event schedules at third locations approximate to the first and second geographic locations, the additional information used to create a predicted human density map including the first and second geographic locations as a result of the request.

14. The method of claim 10 wherein the plurality of mobile computerized devices are smartphones, and metadata associated with the third data from the mobile computerized devices is used in the generation of the human density map.

15. The method of claim 10 wherein the stationary sensors and the sensors connected to the plurality of mobile computerized devices are any one of a web cam, video, microphone, thermistor, barometer, light meter, and wireless signal detector.

16. The method of claim 11 wherein the control of the timing and the data gathering at all of the sensors occurs by communications from the server to the plurality of mobile computerized devices and local computerized devices, and includes;
a request for information regarding the configuration, intensity, and direction of the sensors, and
information for directing the type, amount, and timing of the first, second and third data to be transmitted to the server.

17. The method of claim 13, wherein the first, second and third data gathered by the server is stored as historical data to be utilized in the generation of the predicted human density maps based upon future requests.

18. The method of claim 13, wherein the server determines current human density at least at a third geographic location via data gathered from sensors and GPS connected to mobile computerized devices at the third geographic location, and uses that determination to predict human density at the first and second geographic locations, creating a predicted human density map in the display representing a future time of the first and second geographic locations in the display at a future time.
